(19) United States
(12) Patent Application Publication
(10) Pub. No.: US 2006/0112742 A1
(43) Pub. Date: Jun. 1, 2006

(54) Integrated safety locking device

(76) Inventors: Gil Strauss, Azmon (IL); Yoav Redlich, Kfar Hamacabi (IL); Felix Shestatski, Karmiel (IL); Gal Moyal, Haifa (IL)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 11/285,822

(22) Filed: Nov. 23, 2005

(30) Foreign Application Priority Data
Nov. 26, 2004 (IL) 165393

(51) Int. Cl. F16K 35/10

(52) U.S. Cl. 70/177

(57) ABSTRACT

A locking device integrated in a control knob, a control device, a valve and the like, configured to rotate with respect to a seating therebeneath and having a latching device that includes a latch plate configured to slidingly reciprocate within a housing inside the control knob. The latch plate has a tongue appended thereto and protruding therebeneath for releasably engaging a slot in the seating, such that when the latch plate is in the outer position, the tongue engages the slot and latches the control knob preventing its rotation with respect to the seating, and when the latch plate is in the inner position, the tongue is disengaged from the slot and is unlatched from the control knob, allowing its rotation with respect to the seating.

### BACKGROUND OF THE INVENTION

1. Field of the Invention

The present invention relates to control devices, such as valves and the like.

2. Background of the Related Art

There is a reliance on control devices such as valves wherever the flow of gases and liquids through pipe-work needs regulating. These valves find a wide range of application, including bulk chemical manufacturing, oil refining and the pharmaceutical and semiconductor industries. Similar valves, albeit generally on a smaller scale, are used in research, and even in domestic plumbing and heating systems, and in car engines, for example.

Often, particularly where inflammable, highly toxic or otherwise dangerous substances are used, the flow valves must be fail safe, and it is critical to ensure that they may be locked in the fully closed position such that flow cannot be restarted inadvertently, such as by mechanical vibration or by accidental or unauthorized human intervention, for example. This may be achieved by using lockable valves.

Conventional lockable valves require padlocks or the like, to lock the valve handle in either fully open or fully closed positions. These prior art devices have proved insufficiently protected. They are usually unreliable, susceptible to damage, difficult to control and typically require additional fixtures or external components such that the space that they require for installation and operation exceeds their basic size. Sometimes appendages such as Lock-out Tag-out devices are required. These require storage near to the valve, typically within the same control box, and require additional maintenance.

In some embodiments, the locking device extends radially beyond the footprint of the valve body.

Thus, despite the crowded prior art, there is still a need for a compact yet easily operated lockable valve, particularly one that can be locked in the fully closed position, and the present invention addresses this need.

### OBJECT AND SUMMARY OF THE INVENTION

It is an object of the preferred embodiments of the invention, to provide manually operated valves including means to prevent inadvertent rotation of the control knobs.

The present invention is directed to a locking device integrated in a control knob configured to rotate with respect to a seating there beneath, comprising a latching means having a latch plate configured to slidingly reciprocate within a housing inside the control knob, between an inner position and an outer position; the latch plate having a tongue appended thereto and protruding therebeneath for releasable engaging a slot in said seating; such that when latch plate is in the outer position, said tongue engages said slot and latches said control knob preventing its rotation with respect to said seating, and when said latch plate is in the inner position, said tongue is disengaged from said slot and is unlatched from said control knob, allowing its rotation with respect to said seating.

Preferably, the valve further comprises a hookian member for urging said latch plate outwards towards its latching position.

Typically, the valve is for the controlling of fluid flow through a conduit, such as a pipe or an orifice.

In preferred embodiments, the locking device further comprises an anchor hole through said latch plate, for enabling the valve to be locked by passing a locking device such as a padlock shackle, a LOTO (Lock-out Tag-out) device, a cord, a cable or a locking rod therethrough.

In preferred embodiments, the locking device is compact and may be designed that it does not extend radially beyond the footprint of the valve body.

In preferred embodiments, the locking device is compact and enables an arrangement of the valves in such a manner that they are aligned as parallel either horizontally or vertically so that no additional space is required.

By fluid, any substance that may flow through pipe work is intended, including gases, liquids, gels, slurries and suspensions, for example.

By flow valve, all types of valves allowing flow of fluids through pipe work or orifices are intended, including stopcocks, taps, and the like.

By control knob, any manually operated handle is intended.

Various other objects, advantages and features of the present invention will become readily apparent to those of ordinary skill in the art, and the novel features will be particularly pointed out in the appended claims.

### BRIEF DESCRIPTION OF THE DRAWINGS

For a better understanding of the invention and to show how it may be carried into effect, reference will now be made, by way of example, to the accompanying drawings in which one embodiment of the present invention is shown, thereby making apparent to those skilled in the art how the invention may be embodied in practice.

It is stressed that the particulars shown are by way of example and for purposes of illustrative discussion only, and are presented in the cause of providing what is believed to be the most useful and readily understood description of the principles and conceptual aspects of the invention. In this regard, no attempt is made to show structural details in more detail than is necessary for a fundamental understanding thereof. In the accompanying drawings:

FIG. 1 is an isometric projection of one embodiment of the invention, specifically a lockable diaphragm valve, in the latched closed position wherein the latch is slid outwards.

FIG. 2 shows a cross section through the locking device of FIG. 1 in its latched position, showing the basic internal structure thereof.

FIG. 3 shows a cross section through the locking device of FIG. 1 in its unlatched position, wherein the latch thereof is slid inwards, into the handle and out of its latch slot.

FIG. 4 is an isometric projection of the valve of FIG. 1, in the unlatched position of FIG. 3.

FIGS. 5a, 5b and 5c are front elevation, side elevation and plan views of the latched locking device of FIG. 1 showing how the latch plate does not protrude beyond the valve body footprint.

FIG. 6 is an isometric projection of the latched locking device of FIG. 1 in its closed position, locked with a standard padlock.

FIG. 7 is an isometric projection of the latched locking device of FIG. 1 in its closed position, locked with a standard LOTO (Lock-out Tag-out) device.

FIG. 8 shows a series of the latched locking device of FIG. 1 in co-alignment, locked by a cable.

FIG. 9 shows a series of the latched locking device of FIG. 1 in co-alignment, locked by a locking rod.

FIG. 10 is an isometric projection of a second embodiment of the present invention being a latchable two-way ball valve latched in the shutoff position.

FIG. 11 shows the latch plate of the locking device of FIG. 10 in the latched closed position.

FIG. 12 shows the latch plate of the locking device of FIG. 10 in the unlatched position.

FIGS. 13a, 13b and 13c are front elevation, side elevation and plan views, respectively, of the locking device of FIG. 10.

### DETAILED DESCRIPTION OF THE PREFERRED EMBODIMENTS

The present invention provides a novel integral latching means for latching control knobs, particularly, but not exclusively, the handles of manually operated valves and the like, to prevent inadvertent rotation thereof. In preferred embodiments, the latching means is lockable, to prevent the control knob from being tampered with by unauthorized personnel, for example.

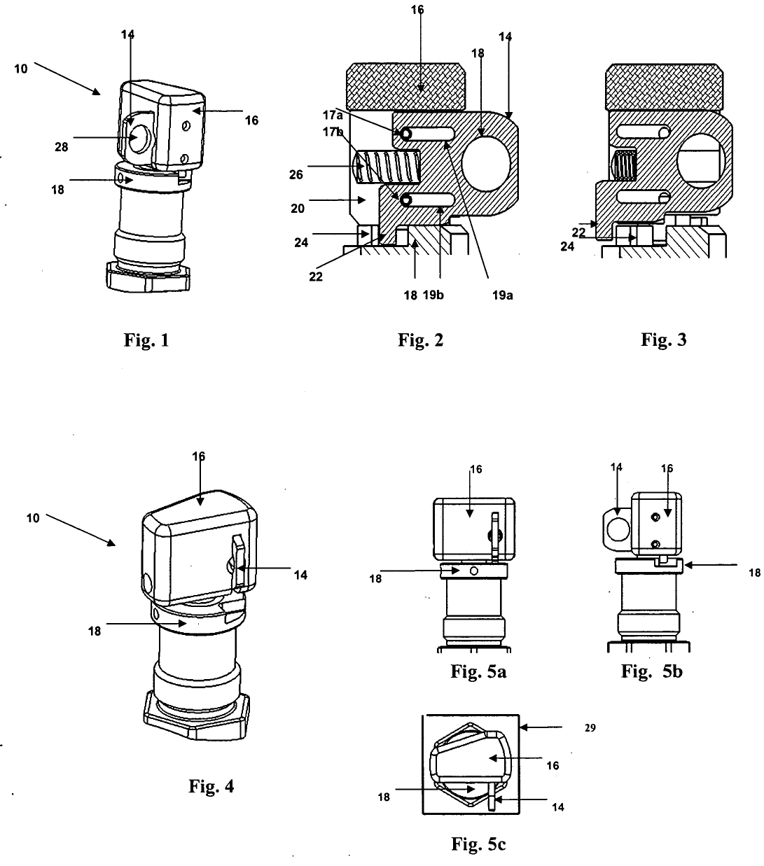

By way of example, with reference to FIGS. 1 to 5, a first embodiment of the present invention, specifically a diaphragm valve having an integral locking device in a control knob is described.

Diaphragm valves consist essentially of control knobs rotatably mounted on seatings. They allow the control of fluid flow through conduits, such as piping or manifold.

The diaphragm stem valve 10 of the first embodiment includes a latching means consisting of a latch plate 14 that is able to slidingly reciprocate between a latched position as shown in FIGS. 1, 2 and 5, and an unlatched position as shown in FIGS. 3 and 4. In the latched position, the control knob 16 is prevented from rotating with respect to its seating 18, whereas in the unlatched position, the control knob 16 is free to rotate, allowing controlling of fluid through a conduit, such as a pipe or orifice (not shown).

With particular reference to FIGS. 2 and 3, the latch plate 14 may be slid inwards and outwards within its housing 20. The latch plate 14 includes a slit 17a through which a stop 19a passes, thereby preventing the latch plate from sliding too far in either direction. Preferably for stability, a pair of such stops 19a, 19b passing through a pair of parallel slit 17a, 17b are provided for this purpose. A tongue 22 protruding therefrom is configured, such that when slid outwards (FIG. 2), it engages a slot 24 in the seating 18 preventing the control knob 16 from rotating and thereby latching it closed. When slid inwards (FIG. 3), the tongue 22 disengages the slot 24, unlatching the control knob 16 and allowing it to be rotated. Usefully, a hookian member, such as a helical spring 26 is incorporated, and when the knob is in the closed position, such that the tongue 22 is aligned with the slot 24, spring 26 urges the latch plate 14 outwards, latching the control knob 16, thereby preventing it from being inadvertently opened.

An anchor hole 28 through the latch plate 14 is also provided, which allows the latch plate 14 to be locked in the latching position, thereby locking the control knob 16 and preventing the valve 10 from being opened.

As best shown in FIG. 5c, the latch plate 14 may be designed such that it is compact, and in the latched position does not protrude beyond the valve footprint 29 thereof.

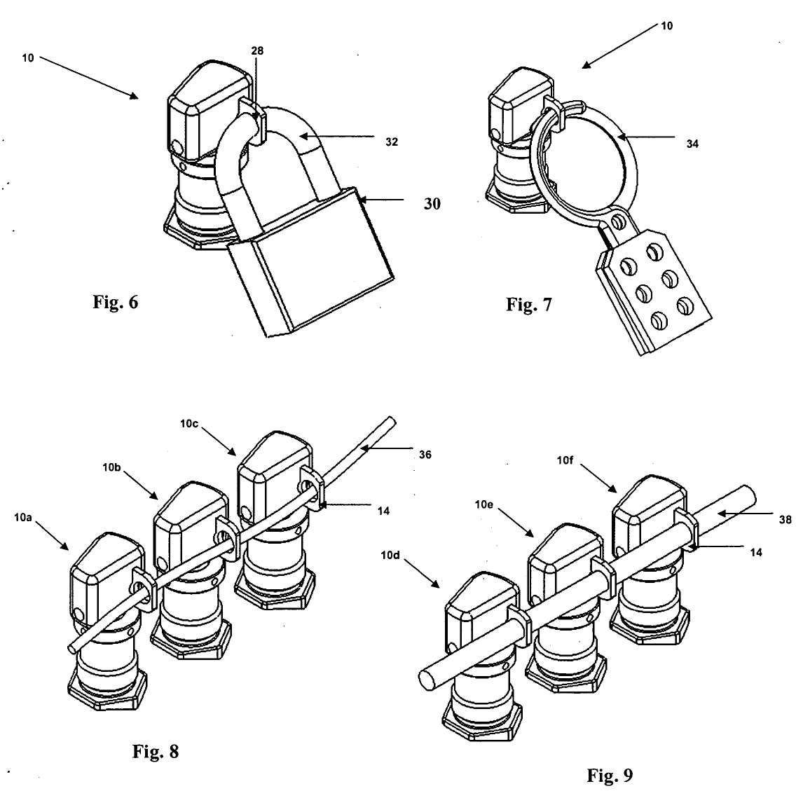

With reference to FIG. 6, the latch plate 14 may be locked via a padlock 30, the shackle 32 thereof, passing through the anchor hole 28. Similarly, as shown in FIG. 7, the latch plate may be locked with a LOTO (Lock-out Tag-out) device 34, which is a prior art device designed to enable up to six different locks to be used in tandem.

As shown in FIG. 8, a flexible cord 36, such as a woven steel rope may be run through the anchor holes 28 of a plurality of latch plates 14, locking several valves 10a-c thereby. Thus a series of valves mounted in a gas box or gas panel, for example, can be locked in the shutoff position with a single cable. The distance between the valves may be several meters of course. Within gas cabinets, several valves are often arranged in a line, and, as shown in FIG. 9, a locking rod 38 may be used to lock such a line of valves 10d-f.

In this manner valves may be safely locked in their shutoff positions wherein all fluid flow therethrough is curtailed, such that three distinct and independent actions are required to bring the valve into an open position.

It is understood, of course, that the present invention is not limited to diaphragm valves, and lockable latching means as described hereinabove may be incorporated into other fluid valves.

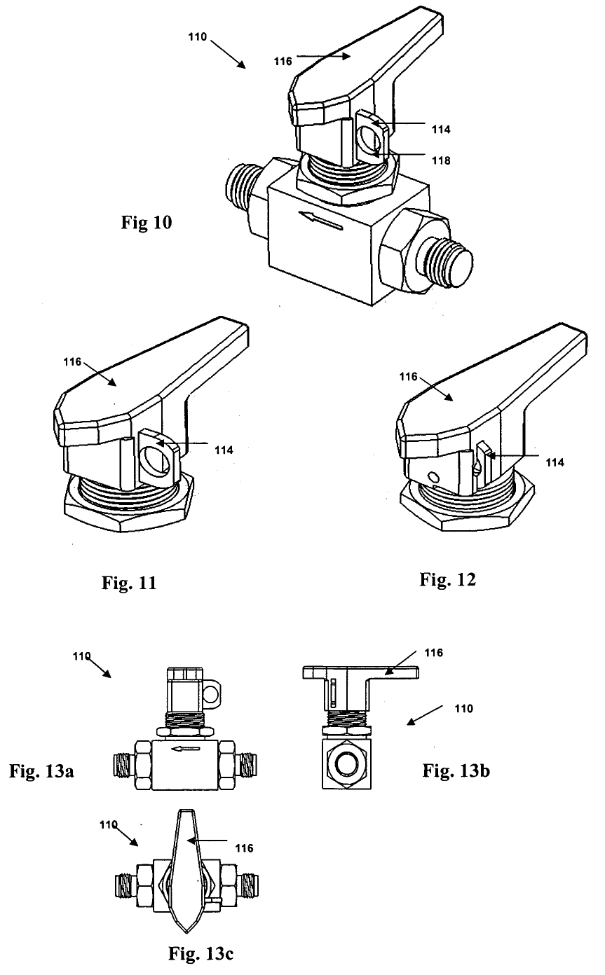

As shown in FIGS. 10 to 13, a second embodiment of the invention is a latchable two-way ball valve 110 that is similar to prior art two-way ball valves, but which includes a latch plate 114 having an anchor hole 118 therethrough, configured to slide back and forth in a housing (not shown) through the handle 116 thereof, between a latched position (FIG. 11) and an unlatched position (FIG. 12).

Similarly, lockable latching means can be applied to both manual and “hybrid” (i.e. manual & pneumatic) diaphragm valve systems and standard ball valves, as locking devices in two-way valves or as positioning mechanisms in three-way ball valves.

Valves including the latching means of the present invention have many advantages over those of the prior art. They meet the requirements for Control of Hazardous Energy, for example. Since the latching mechanism is typically compact and does not exceed the breadth of the base of the valve, no additional space is required. Multiple valve arrangements aligned in parallel, either horizontally or vertically are possible.

The operator is not required to pay special attention to ensure that the valve is locked. It will be automatically latched when the knob is turned to a closed position. In diaphragm valves, as most commonly used in clean environment applications, the control knob and locking device need not exceed the valve outline. This feature is of great importance, especially in “Surface Mount” applications where gas box valves and other components are mounted on a special manifold that replaces traditional connecting pipes, and the space occupied by each valve requires to be kept to a minimum. Particularly in semiconductor manufacturing systems major efforts are invested to minimize the space that valves occupy since space in clean rooms is at a premium, whereas prior art solutions typically contribute to the valve footprint or add to external devices to valves or require additional actions of the operator, prior to locking the valve.

In corrosive environments, all parts of the Locking device of the present invention may be manufactured from resistant materials such as ASTM SS 316 or ASTM SS 304 stainless steels. To allow differentiation, the control knobs themselves may be constructed of anodized aluminum allowing a range of colors.

To release a valve of the present invention from its locked position an operator must first remove the locking device from the anchor hole thereof, then push the latch plate into the control knob thereby unlatching it, and only then can the operator rotate the control knob.

However, the latch itself is sufficient to prevent a valve from being opened inadvertently even when no locking equipment is used.

It is understood that latching means in general and lockable latching means in particular may be incorporated into control knobs of other valves, not just of fluid valves. Thus, other embodiments of the present invention include control knobs of valves for electrical components, for example.

Furthermore, although typically such devices will be configured to be latchable in their closed or shutoff positions, valves may be fabricated to include a latching means configured to latch the valves in the open position, and be lockable in the open position, such that their closure requires manual intervention.

Persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

What is claimed is:

1. A locking device integrated in a control knob configured to rotate with respect to a seating therebeneath, comprising:
a latching means including a latch plate configured to slidingly reciprocate within a housing inside the control knob, between an inner position and an outer position; the latch plate having a tongue appended thereto and protruding therebeneath for releasably engaging a slot in said seating; such that when the latch plate is in the outer position, said tongue engages said slot and latches said control knob preventing its rotation with respect to said seating, and when said latch plate is in the inner position, said tongue is disengaged from said slot and is unlatched from said control knob, allowing its rotation with respect to said seating.

2. The locking device of claim 1, further comprising a hookian member for urging said latch plate outwards towards its latching position.

3. The locking device of claim 1, wherein the locking device is integrated in a control knob of a valve.

4. The locking device of claim 3, further comprising an anchor hole through said latch plate, for enabling the valve to be locked by passing an external locking device therethrough.

5. The locking device of claim 4 wherein said locking device being selected from a list of padlock shackles, LOTO devices, cords, cables and locking rods.

6. The locking device of claim 4, wherein the locking device allows for the alignment of the valves as parallel either horizontally or vertically so that no additional space is required.mmm

7. The locking device of claim 1, wherein the seating is designed so that it does not extend the valve body footprint thereof.
